(19) United States
(12) Patent Application Publication
(10) Pub. No.: US 2023/0238721 A1
(43) Pub. Date: Jul. 27, 2023

(54) JUMPER CABLE CLAMP

(71) Applicant: Ningbo Elanteam International Co., Ltd., Ningbo (CN)

(72) Inventor: Johnny Chi-Pao Liao, Irvine, CA (US)

(21) Appl. No.: 18/101,537

(22) Filed: Jan. 25, 2023

Related U.S. Application Data
(60) Provisional application No. 63/302,981, filed on Jan. 25, 2022.

(51) Int. Cl. H01R 11/24

(52) U.S. Cl. CPC H01R 11/24; H01R 2201/26

(57) ABSTRACT

A jumper cable clamp having a spring which urges the clamp handles in an open position and a locking mechanism on the handles to maintain the handles in a closed position. An electrical wire connector is connected to a distal end of one of the handles, which can be formed from an electrically nonconductive material.

### CROSS-REFERENCE TO RELATED APPLICATIONS

This claims the benefit of priority under 35 U. S. C. § 119(e) from U.S. Patent Application No. 63/302,981, filed Jan. 25, 2022. The disclosure of the foregoing application is incorporated herein by reference in its entirety.

### INTRODUCTION/BACKGROUND

Jumper cables are used to start cars with drained batteries and to charge batteries. Separate cables are attached at one end to the positive or negative terminal of a battery to be charged, and at the other end are placed in electrical communication with a source of electrical charge, generally either the battery of another car or a portable battery capable of charging an automobile battery.

The clamps of prior art jumper cable systems are designed so that the two jaws of a clamp are urged into a closed position by a spring which pushes the ends of the clamp toward each other and pushes the handle ends outwardly. Such springs exert sufficient force for the clamp to securely grip a battery terminal when placed on the terminal, forcing a user to exert force in order to separate the jaws of the clamp sufficiently to be able to place the clamp on the terminal. The amount of force needed to be applied by the user can make it more challenging to accurately place the clamp on the terminal without inadvertently touching another clamp of the jumper cable system or a portion of an automobile and thereby accidentally creating a closed circuit and/or bridging the battery terminals. There is therefore a need for a jumper cable clamp which is safer and easier to use than current designs.

### SUMMARY

In the present jumper cable clamp, a spring is used to urge the clamp handles into an open position rather than into a closed position, and the clamp is maintained in a closed position with a locking mechanism on the handles. An electrical wire connector is preferably placed in electrical communication with a proximal end of a jaw of the clamp which is adjacent to a distal end of the handle adjacent to the jaw.

### BRIEF DESCRIPTION OF THE DRAWINGS

FIG. 1 is top plan view of a prior art jumper cable clamp in the closed position.

FIG. 2 is top plan view of a prior art jumper cable clamp in the open position.

FIG. 3 is top plan view of a prior art jumper cable clamp attached to a battery terminal.

FIG. 4 is top plan view of an embodiment of the present jumper cable clamp in the closed position.

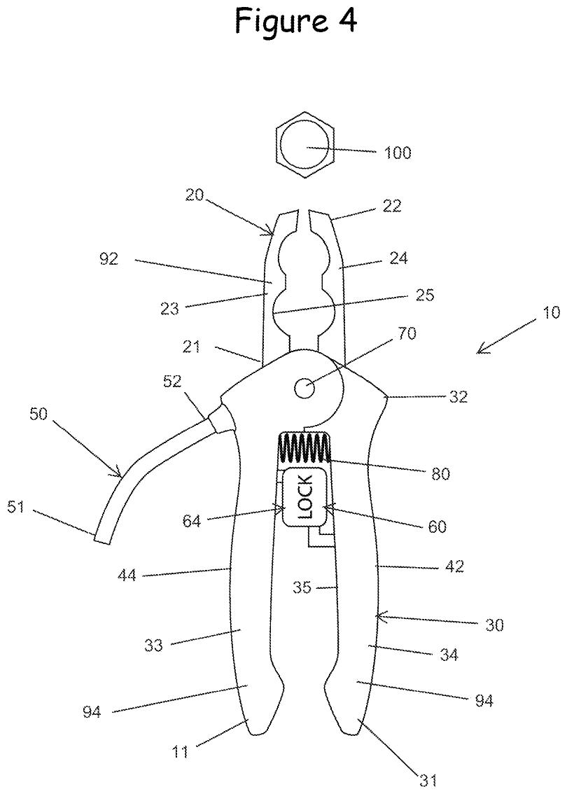

FIG. 5 is top plan view of the clamp of FIG. 4 in an open position, prior to attachment to a battery terminal.

FIG. 6 is top plan view of the clamp of FIG. 4 in a closed position and attached to a battery terminal.

FIG. 7 is top plan view of the clamp of FIG. 4 following release of the clamp from a terminal.

The reference numbers in the figures have the following meanings:

| Component | Reference Number |
|---|---|
| Clamp | 10 |
| Clamp proximal end | 11 |
| Clamp distal end | 12 |
| Jaw | 20 |
| Jaw proximal end | 21 |
| Jaw distal end | 22 |
| Left side jaw portion | 23 |
| Right side jaw portion | 24 |
| Jaw inner side | 25 |
| Jaw inner side first portion | 26 |
| Jaw inner side second portion | 27 |
| Handle | 30 |
| Handle proximal end | 31 |
| Handle distal end | 32 |
| Left side handle portion | 33 |
| Right side handle portion | 34 |
| Handle inner side | 35 |
| First rotating unit | 42 |
| Second rotating unit | 44 |
| Electrical wire | 50 |
| Electrical wire proximal end | 51 |
| Electrical wire distal end | 52 |
| Electrical current | 55 |
| Locking mechanism | 60 |
| Hook | 62 |
| Catch | 64 |
| Hinge | 70 |
| Spring | 80 |
| Metal | 92 |
| Insulator | 94 |
| Terminal | 100 |

### DETAILED DESCRIPTION

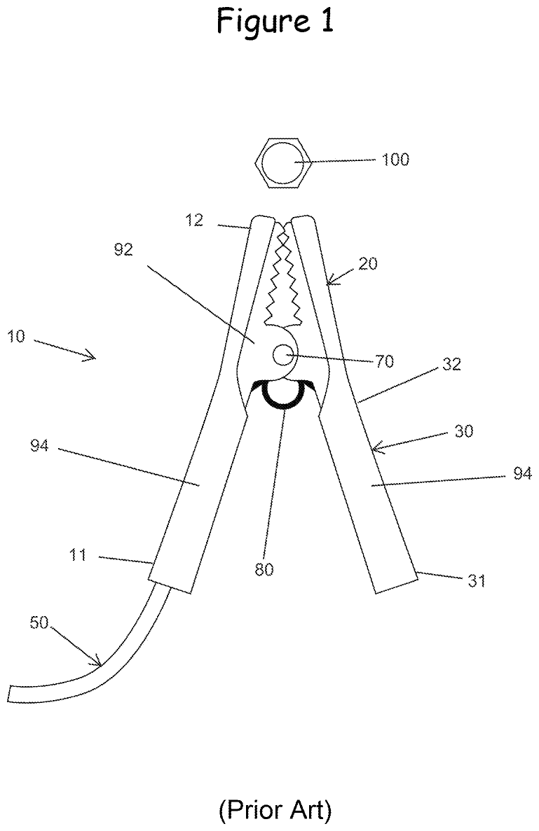

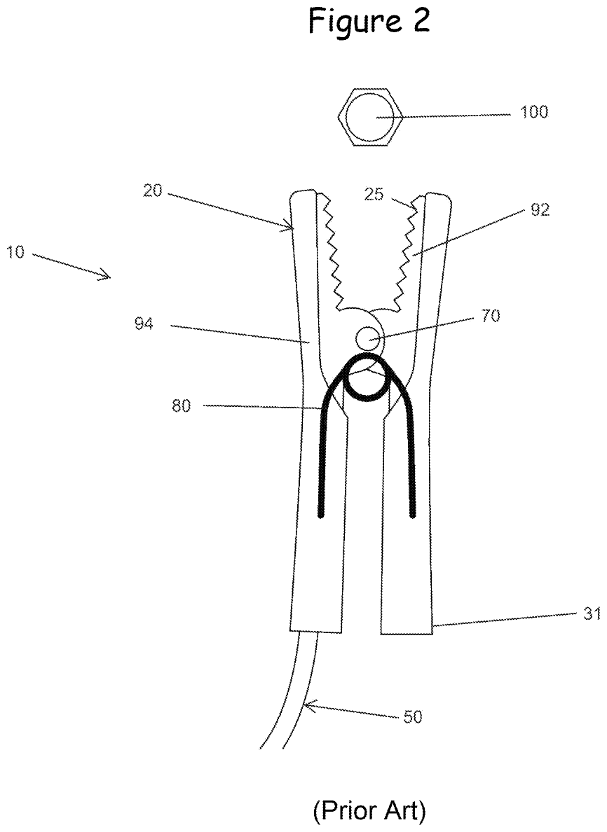

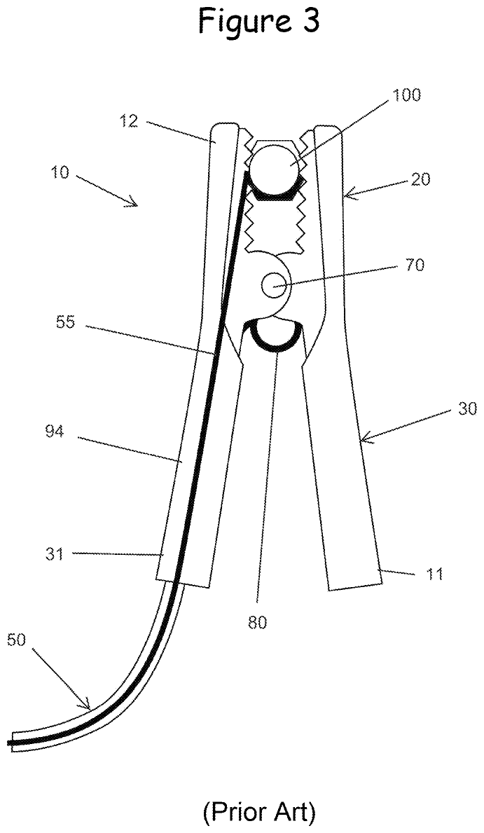

As shown in FIGS. 1-3, prior art jumper cable clamps maintain the clamp ends in a tightly closed position by a spring which pushes the jaw ends closed and the handle outward. The handles and jaws of the clamp generally include a metal core, with the right side handle and right side jaw being integrally formed or at least in electrical communication, and the left side handle and left side jaw likewise being integrally formed or in electrical communication. An electrically conductive wire in communication with a source of electricity is connected to a proximal end of one of the handles, so that when the clamp is attached to a terminal, an electrical current flows through the metal core of the handle to the distal end of the clamp. This requires the core of the handle to be electrically insulated so that a user can safely grip it, and poses a potential risk or danger if the insulating material around the handle becomes frayed or broken. When the clamp is to be removed from a terminal, force must be exerted on the handles to force the jaws into an open position.

By contrast, in the present clamp design a spring does not force the clamp jaws closed but instead urges the handles of the clamp into an open position. Only a gentle force is needed for this, much less than the force used in prior art clamps to secure clamp jaws to a battery terminal. The clamp is maintained in a closed position and secured to a battery terminal with a locking mechanism on the clamp's handles, instead of relying on a spring force. The spring can be located between the handles, preferably in a distal portion of the handles, extending between the inner side of the right side handle and the inner side of the left side handle. The lock and spring can be made from metal or other conductive materials without the risk of forming an electrical connection, because current is not conducted through the handles of the clamp as in prior art designs.

In one embodiment, the right side handle is integrally formed with or mechanically connected to the left side jaw portion of the clamp, and likewise the left side handle is integrally formed with or mechanically connected to the right side jaw portion. In this embodiment, the right side handle and left side jaw portion form a first rotating unit and the left side handle and right side jaw portion form a second rotating unit. In this way, when the spring urges the right side handle further from the left side handle in order to open the clamp, the left side jaw and right side jaw are correspondingly pushed away from each other. The opposite occurs during closure of the clamp. The first and second rotating units are rotatably connected by a hinge, which serves to attach the rotating units of the clamp and also allow rotation around the hinge.

The smaller amount of force exerted by the spring allows plastic and other non-metal materials to be used to form all or a greater portion of each of the handles. This further allows the electrical wire of the jumper cable which is in communication with a source of electricity to be connected at a distal end of a handle, instead of connecting it to the handle at the proximal (bottom) end of the clamp as in prior art designs. In this way, a user's hands are less likely to be inadvertently exposed to an electrical current if the material covering the handles is frayed or damaged, since the handles of the present clamp do not require a structural core made of metal as in prior jumper cable clamps.

The present clamp 10 has a proximal end 11 and distal end 12 and generally comprises a jaw portion 20 and handle portion 30. The jaw 20 has a proximal end 21 and distal end 22 and comprises a left side jaw portion 23 and right side jaw portion 24. At least an inner side 25 of the jaw 20 is formed from a metal or other conductive material and is in electrical communication with an electrical wire 50. The inner side 25 of the jaw 20 can advantageously comprise a shape which intimately contacts a portion of a battery terminal 100 in order to increase the area of contact between a jaw portion and the terminal 100. For example, the inner side 25 can be curved or arcuate in order to better conform to the sides of a battery terminal, which may have a cylindrical shape. The inner side 25 can alternatively have one or more inwardly facing flat sides disposed at angles in order to conform to nuts which may be in electrical communication with a battery terminal. In one embodiment, the inner side 25 of the jaw 20 of the present clamp 10 can comprise a plurality of conformations in order to better contact a battery terminal. For example, the left side jaw portion 23 and right side jaw portion 24 can each comprise an inner side first portion 26 and an inner side second portion 27, where the inner side first portion 26 on each jaw portion is spaced apart from the inner side second portion 27, as shown in the illustrated embodiments of the present clamp.

The handle 30 of the present clamp is connected to the jaw 20 at a distal end 32 of the handle and extends to a proximal end 31, and has a left side handle portion 33 and right side handle portion 34. The left side handle portion 33 is mechanically connected to or integrally formed with (i.e., attached to) the right side jaw portion 24 to form a first rotating unit 42, and the right side handle portion 34 is mechanically connected to or integrally formed with the left side jaw portion 23 to form a second rotating unit 44. If the respective jaw and handle portions of the first and second rotating units are integrally formed, then the handle portions should be covered with an electrically insulating material in order to avoid conducting current through the handles 30 to a user when the clamp 10 is placed on or removed from a battery terminal 100. In one embodiment, the jaw portions of the first and second rotating units are integrally formed with the distal ends of the handle portions, and the proximal ends of the handle portions are formed from an electrically nonconductive material. If the left side handle portion 33 is mechanically connected to the right side jaw portion 24 and the right side handle portion 34 is mechanically connected to the left side jaw portion, i.e., such that the handle and jaw portions are separately formed pieces, then the handle portions can be partially or completely formed from a nonconductive material in order to avoid user injury. The first rotating unit 42 and second rotating unit 44 are joined at a hinge 70, which can comprise a pin or other mechanism around which the first and second rotating units can be rotated. When the inner side 35 of the left side handle portion 33 is urged closer to the inner side 35 of the right side handle portion 34, the first rotating unit 42 is rotated around the hinge 70 with respect to the second rotating unit 44, and the inner side 25 of the left side jaw portion 23 is urged closer to the inner side 25 of the right side jaw portion 24 toward a relatively closed position.

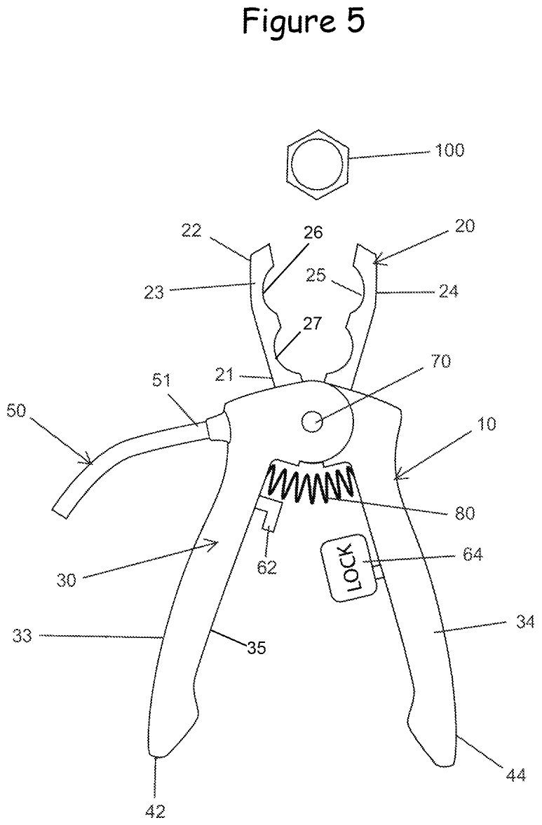

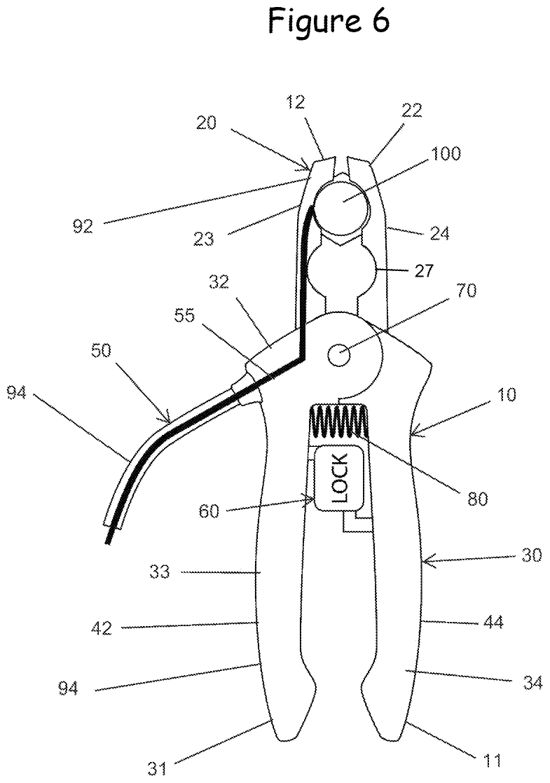

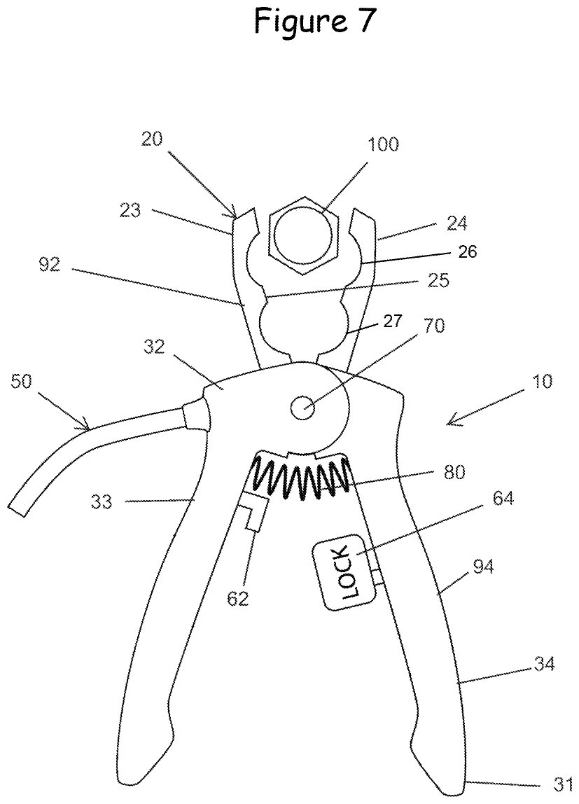

When the clamp is in the closed position, a locking mechanism 60 can be reversibly engaged in order to maintain the first rotating unit 42 and second rotating unit 44 in a fixed position with respect to each other, thereby fixedly clamping the jaw 20 of the clamp 10 on a terminal 100. The locking mechanism 60 can be any of a number of known mechanisms for reversibly fixing the first rotating unit 42 and second rotating unit 44 in place. For example, a curved bar or lever (pawl) secured to one handle can engage teeth or grooves (such as on a ratchet) on the other handle. In the illustrated embodiments, the locking mechanism 60 comprises a hook 62 which can be placed over a catch 64 by a user. The hook is located on the inner side of one handle and can be placed in proximity to the catch attached to the inner side of the other handle of the clamp when the handles are urged from an open position (as shown in FIG. 5) into a closed position (as shown in FIG. 6), and the hook can thereby be secured to the catch. Disengaging the hook from the catch then allows the clamp to be returned to the open position (as shown in FIG. 7).

When the locking mechanism 60 is disengaged, a spring 80 urges the left side handle 33 portion further away from the right side handle portion 34 and urges the left side jaw portion 23 further away from the right side jaw portion 24, thereby rotating the first rotating unit 42 around the hinge 70 with respect to the second rotating unit 44 toward an open position which allows the jaw 20 to be placed on or removed from a terminal 100. The spring 80 extends between the inner side 35 of the left side handle portion 33 and inner side 35 of the right side handle portion 34 and is elastically compressed when the locking mechanism 60 is engaged. When the locking mechanism 60 is disengaged, the spring 80 urges the left side handle portion away from the right side handle portion toward an open position. In the illustrated embodiments a coiled metal spring is used, but a number of spring mechanisms known to the art can alternatively be used.

To secure the present clamp onto a battery terminal, the clamp is placed in an open position with the jaws spaced apart, and the handles of the clamp are urged closer together (squeezed) against the gentle force exerted by the spring between the handles, until the inner surface of each of the jaws is in contact with the terminal. In order to maintain the jaws in contact with the terminal, the jaws are secured in a closed position with a locking mechanism which secures the handles in the closed position. To release the clamp from the terminal, the locking mechanism is unlocked and the clamp is urged into the open position by the spring.

In order to provide electricity to a drained battery in need of charging, a source of electricity (voltage) is placed in electrical communication with the jaw 20 by means of an electrically conductive wire 50 having a non-conductive material on its exterior surface. The wire 50 is connected to or otherwise in electrical communication with at least one of the jaw portions at a proximal end 51 of the wire, and extends to a distal end 52 which is connected to or otherwise in electrical communication with the source of electricity which passes electrical current 55 through the wire 50 when the clamp is placed on the terminal 100 of a drained battery. Preferably, the wire 50 is placed in electrical connection with a jaw portion of the jaw 20 at or adjacent to a distal end 32 of a handle portion of the clamp, and extends distally from the distal end of the handle portion to the source of electricity. In such embodiments the wire is not placed in electrical communication with a medial or proximal end 31 of a handle portion of the clamp and therefore can be physically connected to the clamp at a distal end 32 of the handle. The handle 30 in such embodiments can be formed from a material which is not electrically conductive.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. The terms “top,” “bottom,” “right,” “left,” and other terms of relative position or orientation as used herein refer to a relative position of one component of the present device with respect to others. The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

What is claimed is:

1. A jumper cable clamp having a proximal end and distal end, comprising:
a jaw having a proximal end, a distal end, and an inner side, the jaw comprising a left side jaw portion and right side jaw portion,
a handle having a proximal end and distal end and comprising a left side handle portion and right side handle portion,
a locking mechanism, wherein the locking mechanism can be engaged in order to fix a position of the left side handle portion with respect to the right side handle portion, and wherein the locking mechanism can be reversibly engaged and disengaged,
a spring extending between the left side handle portion and the right side handle portion, wherein the spring is elastically compressed when the locking mechanism is engaged and urges the left side handle portion away from the right side handle portion when the locking mechanism is disengaged, and
a wire having a proximal end and a distal end, wherein the proximal end is in electrical communication with the jaw, wherein the wire is connected to the distal end of the left side handle portion or the right side handle portion,
wherein the left side handle portion is attached to the right side jaw portion to form a first rotating unit, and the right side handle portion is attached to the left side jaw portion to form a second rotating unit,
wherein the first rotating unit and the second rotating unit are rotatably connected by a hinge,
wherein when the left side handle portion is urged closer to the right side handle portion, the first rotating unit is rotated around the hinge with respect to the second rotating unit and the left side jaw portion is urged closer to the right side jaw portion toward a closed position of the clamp,
wherein the locking mechanism can be reversibly engaged and disengaged when the clamp is in the closed position, and
wherein when the locking mechanism is disengaged, the spring urges the left side handle portion further away from the right side handle portion and urges the left side jaw portion further away from the right side jaw portion, thereby rotating the first rotating unit around the hinge with respect to the second rotating unit toward an open position.

2. The clamp of claim 1, wherein the left side handle portion is mechanically connected to the right side jaw portion.

3. The clamp of claim 1, wherein the left side handle portion is integrally formed with the right side jaw portion.

4. The clamp of claim 1, wherein the handle is formed from a material which is not electrically conductive.

5. The clamp of claim 1, wherein the left side jaw portion and right side jaw portion each comprise an inner side first portion and an inner side second portion, the inner side first portion being spaced apart from the inner side second portion, wherein the inner side first portion has a different conformation than a conformation of the inner side second portion.

6. The claim of claim 5, wherein the inner side first portion has an arcuate conformation.

7. The clamp of claim 1, wherein the locking mechanism comprises a hook which can be placed over a catch.

8. The clamp of claim 1, wherein the spring is a coiled metal spring.
